(19) United States
(12) Patent Application Publication
(10) Pub. No.: US 2010/0273510 A1
(43) Pub. Date: Oct. 28, 2010

(54) DESIGNED CONSOLE FOR PROVIDING A VARIETY OF CELLULAR SERVICES TO A DRIVER OF A MOTOR VEHICLE AND HIS ENVIRONMENT

(75) Inventors: Michael Herman, Ofakim (IL); Danny Knafou, Ofakim (IL)

Correspondence Address: MARSTELLER & ASSOCIATES, P O BOX 803302, DALLAS, TX, 75380-3302, US

(73) Assignee: I. WAY MOBILE LTD., Beer Sheva (IL)

(21) Appl. No.: 12/781,737

(22) Filed: May 17, 2010

Related U.S. Application Data
(63) Continuation-in-part of application No. PCT/IL2008/001510, filed on Nov. 17, 2008.

(51) Int. Cl. H04W 4/20; H04W 4/02

(52) U.S. Cl. 455/456.3; 455/466

(57) ABSTRACT

A system for providing cellular services to a driver of a motor vehicle, comprising a user interface unit that includes: a touchscreen for displaying a desired content and icons being input keys to receive inputs from the driver; a memory with dedicated managing software for controlling the offered services and inputs from the touch-screen; a cellular basic unit for providing voice and data communication between the user interface unit and a cellular base station to thereby provide content and cellular services from one or more remote servers over a data network; a local interfacing application for generating a dedicated interface, adapted to be compatible with the vehicular environment of the driver, by modifying the interface of the content and cellular services being rendered on the remote servers; a processor and operating system for controlling the operation of the user interface unit; a rigid panel for holding the user interface unit; and one or more remote servers for providing content and cellular services to the user interface unit.

### FIELD OF THE INVENTION

The present invention relates to the field of mobile cellular services. More particularly, the invention relates to a robust designed console (apparatus) for providing a variety of cellular services to a driver of a motor vehicle and his environment through a safe and user friendly interface.

### BACKGROUND OF THE INVENTION

There are a lot of modern cellular mobile services that are offered today to a driver of a motor vehicle. The most common services are calling services provided by cellular phone, which is installed in the vehicle normally using a hand-free set that include a mounting structure, an microphone and a loudspeaker, thereby allowing the driver to receive incoming calls and establish outgoing calls. However, in order to do so, the driver must use the inherent user interface of the mobile phone (by depressing keys on its keypad). This may be problematic, since in order to be compact, in many cases the user interface (which normally includes at least keys, a keypad and a display) is designed to be used mostly out of the vehicle, when the interaction time of the driver is not limited and he can pay full attention to the hierarchical menu offered by the mobile phone. Other existing mobile phones that are designed to be used in cars only include larger display and keypads, but still have a basic user interface design which is much like a detachable cellular phone, i.e., requires much attention from the driver in order to fully interact with its features. In addition, the cellular phone is normally installed in a fixed spatial orientation that does not optimally fit more than one driver. Of course, other wireless data communication channels, such as Bluetooth, WiFi (a type of Wireless Local Area Network (WLAN) that use specifications in the 802.11 family), WiMAX (a wireless industry coalition whose members organized to advance IEEE 802.16 standards for broadband wireless access (BWA) networks) etc.

Another common service which becomes widespread is a navigation service, provided either by advanced cellular phones or by a GPS. A Vehicular GPS is normally a pocket PC with a larger display, which is normally installed in the vehicle using a mounting arm that is connected to a mounting base with a suction device that allows the driver to stick it on the front window. This suction device can be removed easily when one needs to, in order to transfer it from one car to another. However, from the same reason, it is not sufficiently secure. In case of an accident, the high impact normally causes it to be detached from the window and hit the driver or one of the passengers in the vehicle, pedestrians out of the vehicle or even hit another car. Therefore, this solution is not safe. In addition, such GPS unit is expensive since it is actually a pocket PC with all the associated and should be removed from the car after each parking, against theft.

All the systems described above have not yet provided satisfactory solutions to the problem of providing a user friendly and safe vehicular device.

It is an object of the present invention to provide a robust apparatus for providing cellular services to a driver of a motor vehicle through a safe and user friendly interface that arises a variety of cellular services that are offered to the driver in a way that is optimally adapted to his needs, both in pull and push modes.

It is another object of the present invention to provide a robust apparatus for providing cellular services to a driver of a motor vehicle, which is cost effective.

It is a further object of the present invention to provide a robust apparatus for providing cellular services to a driver of a motor vehicle, which can be adapted to optimally fit the driver's preferences.

It is yet another object of the present invention to provide a robust apparatus for providing cellular services to a driver of a motor vehicle, which has desired decorative fractures that can be adapted to optimally fit the dashboard of the vehicle.

Other objects and advantages of the invention will become apparent as the description proceeds.

### SUMMARY OF THE INVENTION

The present invention is directed to a system for providing cellular services to a driver of a motor vehicle, that comprises:

a) a user interface unit that includes:
a.1) a touchscreen for displaying a desired content and icons being input keys to receive inputs from the driver;
a.2) a memory with dedicated managing software for controlling the offered services and inputs from the touch-screen;
a.3) a cellular basic unit for providing voice and data communication between the user interface unit and a cellular base station to thereby provide content and cellular services from one or more remote servers over a data network, such as the internet;
a.4) a local interfacing application for generating a dedicated interface, adapted to be compatible with the vehicular environment of said driver, by modifying the interface of said content and cellular services being rendered on said remote servers;
a.5) a processor and operating system for controlling the operation of the user interface unit;
b) a rigid panel for holding the user interface unit; and
c) one or more remote servers for providing content and cellular services to said user interface unit.

It is possible to activate services or applications via the user interface unit by voice commands and associated voice recognition application that is installed in the user interface unit.

The system may further comprise a remote interfacing application residing at an intermediate remote server, or on said remote servers, for interacting with the local interfacing application to jointly generate the dedicated interface and displaying the content in the user interface in a way that is adapted to the environment of the driver.

The user interface unit further may further comprise a mounting arm connected to a rigid mounting base, rigidly connected to the body of the vehicle, such that the panel is being in a spatial orientation desired by the driver.

By using the term cellular services it is meant to include any wireless services that may be provided by a service provider or by a content provider by exchanging data with the apparatus, such as WiFi or WiMAX, advance cellular communication (e.g., 3G).

The user interface unit may further comprises a short-range transceiver and the cellular basic unit is a cellphone with a short-range transceiver used by the driver in the vehicle, which also comprises a short-range transceiver to provide voice and data communication between the user interface unit and a cellular base station through the cellphone.

The arm may further comprise one or more joints to be adjusted by the driver for determining the location and orientation of the UI and a telescopic sleeve for changing the total length of the arm.

The services preferably include music, phone calls, TV, road services, Internet, SMS, email access, or receiving general information. All the services are adapted to the driver environment.

The arm may further comprise one or more joints to be adjusted by the driver for determining the location and orientation of the user interface unit and a telescopic sleeve for changing the total length of the arm.

The user interface unit may further comprise a protecting cover, attached to the edge of the UI by an appropriate hinge and a light sensor for providing data for changing the intensity of the display according to the level of ambient light. Alternatively, the user interface unit may be programmed to change the intensity of the display according to the time.

The user interface unit may further comprise a GPS for providing location based content and cellular services. At least a part of the dedicated interface may generated dynamically, according to the specific accessed content or cellular service and displayed according to a predetermined visual appearance.

The user interface unit may further comprise mechanical connections for allowing a rigid connection to the dashboard of the vehicle.

The user interface unit may be connected to the inherent audio system of the vehicle. Content may be delivered to the user interface unit by streaming.

The system may also include presence sensors for detecting abandoned persons inside the vehicle, distance detection sensors for generating an alarm signal whenever the driver does not keep a minimal safety distance from neighboring vehicles and a rear camera for viewing the road while driving in a reverse direction. Data from these sensors can be transferred to the user interface unit via wired or wireless connection.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 schematically illustrates the system architecture, proposed by the present invention;

FIGS. 2A to 2E schematically illustrate the main menu and sub-menus that can be displayed on the touchscreen of the UI, according to a preferred embodiment of the present invention;

FIG. 3 schematically illustrates the mounting orientation of the UI, according to a preferred embodiment of the present invention; and

FIGS. 4A and 4B schematically illustrate a UI that comprises a cover, according to a preferred embodiment of the present invention.

### DETAILED DESCRIPTION OF PREFERRED EMBODIMENTS

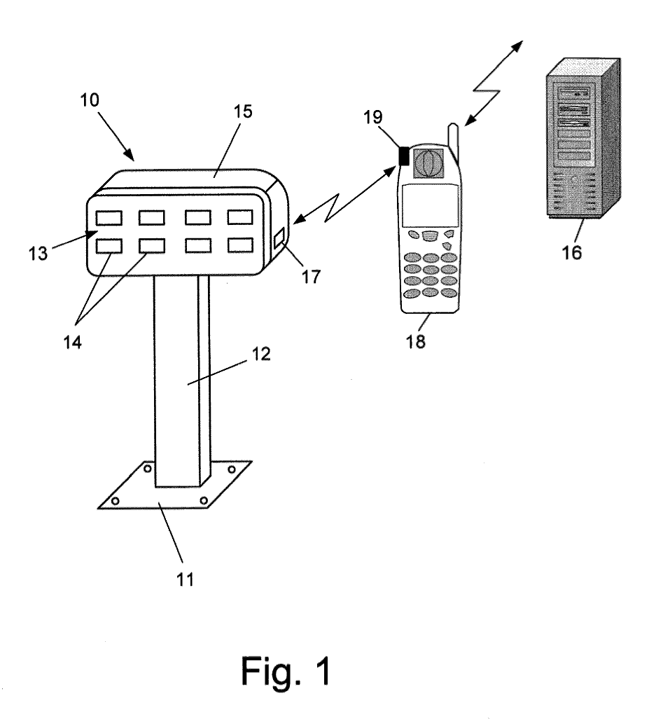

FIG. 1 schematically illustrates the system architecture, proposed by the present invention. The system comprises a user interface (UI) 10 that is robustly installed in the vehicle, such that the mounting will be able to stand in case of an accident or another high mechanical impact. The UI is preferably made of a metallic frame that is connected to the mounting base 11 by a metal arm 12. The UI includes a first layer with touch screen display 13 that is used to display a desired content to the driver, as well as an array of icons 14 of different services. The UI also includes a hardware layer 15 which comprises a processor (CPU) and a memory with dedicated managing software that implements the offered services and controls the inputs from the touch-screen. Such software can be linked to an operating system, such as Microsoft Windows Mobile. The UI also includes a local interfacing application for generating a dedicated interface, which is adapted to be compatible with the vehicular environment of said driver. Adaptation is made by modifying the interface of content and cellular services being rendered on said remote servers, via access to the API of each application that provides access to content or to cellular services. This way, the driver will be able to se large icons which are adapted for consuming and controlling the specific content or application he wishes to interact with. For example, if he requires to hear music, he will be able to select the desired song by pressing an appropriate icon on the touch screen and in addition, to control the playback by a dragging his finger on buttons, a throttle slider or scroll-bars that are displayed on the touch screen. If a different content is desired, another appropriate interface will be displayed. Adaptations of the interface to each content or cellular service may be made in advance or dynamically, on-demand. A remote interfacing application residing at an intermediate remote server, or on said remote servers, may also be used for interacting with the local interfacing application to jointly generate the dedicated interface.

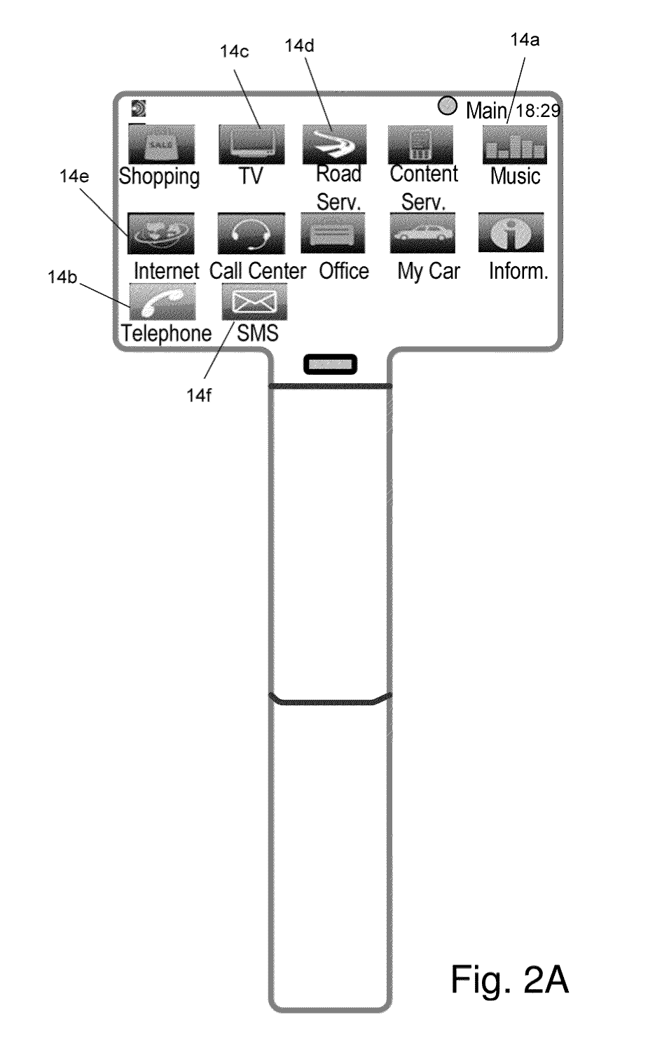

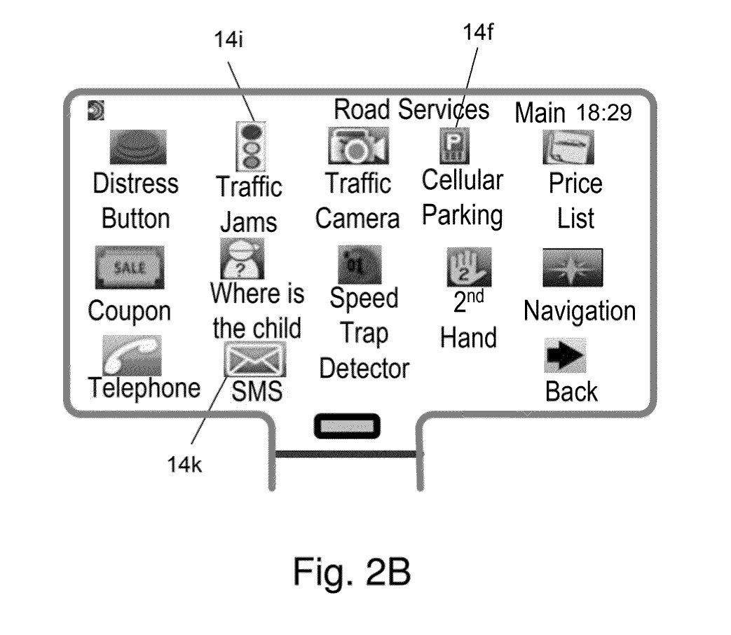

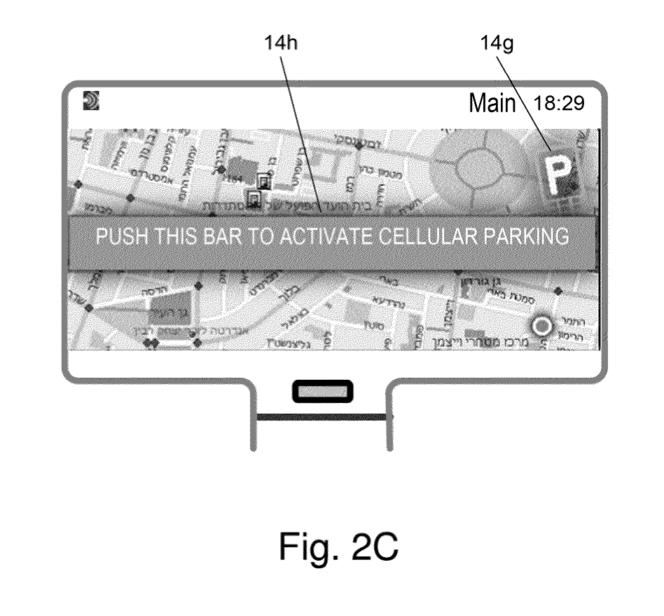

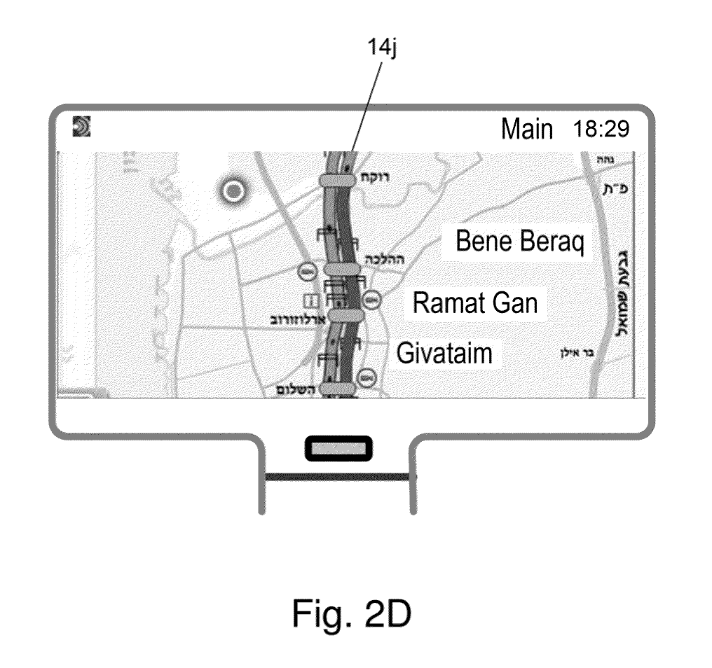

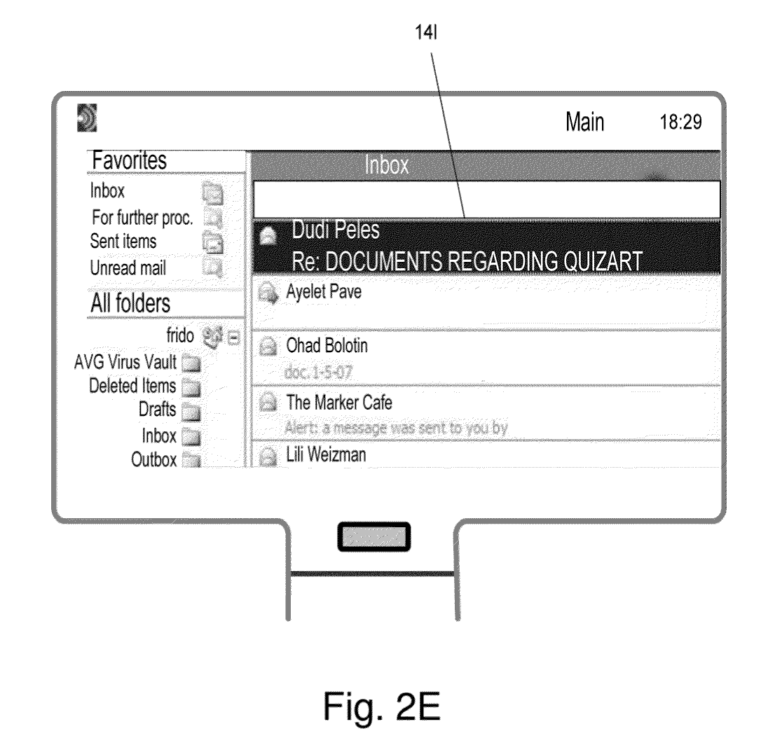

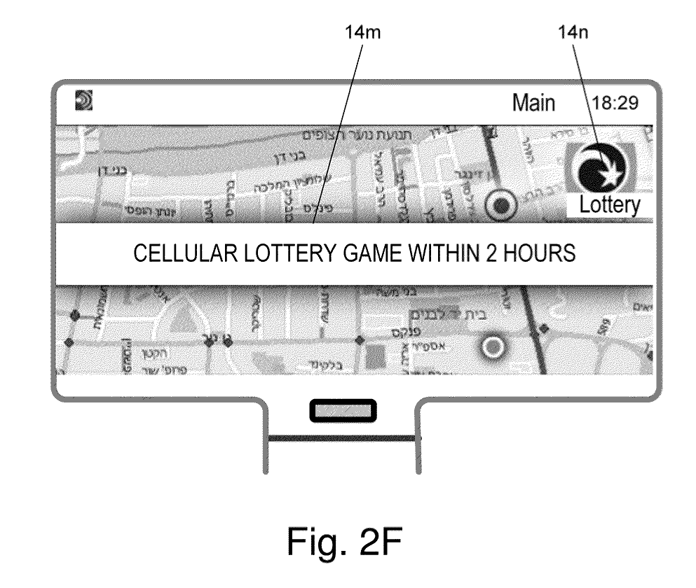

The dedicated user interface may be arranged to collect several applications of services that belong to a particular category into a main icon that represents all these services. The driver can easily access each of these applications of services via this main icon. For example, all the road services world may be represented by a main icon, which leads to a sub-world of all possible services, as shown in FIGS. 2A and 2B.

The hardware layer 15 also includes a cellular basic unit (not shown) that is used to communicate with the nearest base station, so as to provide call services, as well as other desired content services that are selected by the driver or positively offered to him, knowing the location and position of the vehicle, e.g., by a GPS that may be integrated into the user interface unit for providing location based content and cellular services. Such variety of desired services may be offered to the driver without any need for service request and activation. The system proposed by the present invention collects data about the vehicle's location and vehicle position, analyzes this data and offers the relevant services.

The content is located on a remote server 16, in which it can be stored, or alternatively accessed over the internet from one or more remote sources. Alternatively, if the driver already has a regular cellphone 18 with a short range transceiver (e.g., BlueTooth, WiFi, WiMax etc.) 19, the hardware layer 15 includes a sort range transceiver (e.g., BlueTooth) 18 rather that a cellular basic unit. The short range transceiver 17 is used to communicate with the nearest base station through cellphone 18 as a gateway to the cellular network, so as to provide the same services. In case when the vehicle includes an inherent touch screen for activating functions or modules that already exist in that vehicle (e.g., navigation aids, and media), it is possible to use that inherent touch screen and install a reduced version of the system that will be integrated in such a way to exploit the inherent touch screen. This way, the system will upgrade the inherent features that already exist in the vehicle.

FIG. 2A schematically illustrates the main menu displayed on the touchscreen of the UI, according to a preferred embodiment of the present invention. The touchscreen 13 comprises an array of relatively large icons 14, each of which representing a different service. Such services may include:
Music: by pressing icon 14a the driver can reach a sub-menu that will offer him an array of icons that are pre-linked to mp3 audio files according to his predetermined selection. Alternatively, a continuous series determined by the content provider may be played. In this case, the dedicated managing software will download the selected audio file to the memory of the UI, for playback through the inherent audio system of the vehicle, so as to allow the driver to control the audio effects (volume, balance, loudness etc.). In this case, the UI will be connected to the inherent audio system by an appropriate connection (not shown).
Phone: by pressing icon 14b the driver can reach a sub-menu that will offer him an array of icons that emulate a keypad of a mobile phone. In this case, the dedicated managing software will receive his inputs for initiating an outgoing call. Alternatively, if there is an incoming call, the driver will only have to press icon 14b once to receive that call. In this case, is the UI will be connected to the inherent audio system by an appropriate connection (not shown), the driver will be able to hear the caller through the inherent audio system. If not, the voice of the caller will be directed to the speaker of the hand-free set.
TV: by pressing icon 14c the driver can reach a video channel that will be displayed as a full screen, as long as the vehicle is not moving. The channel may be related to a TV station that will be selected by pressing one of the radio channel selection buttons of the inherent audio system. If the is no such inherent audio system, a sub-menu that comprises few icons for selecting TV channels will be displayed. In this case, the dedicated managing software will receive his inputs for TV channel selection and the driver will be able to hear the broadcasted voice via the speaker of the hand-free set.
Road services: by pressing icon 14d the driver can reach a sub-menu that comprises several icons for selecting a desired road service, such as towing. Since the location of the vehicle is always known either by the GPS data of can be derived from the cellular system, the only icons that will be displayed will be linked to the road services that are nearby. By pressing one of these icons, the UI will automatically dial to the selected road service telephone number, so as to initiate a phonecall for placing an order.
Internet: by pressing icon 14e the driver can reach a sub-menu that comprises several icons for browsing and reaching a selection of preferred websites, the web pages of which will be displayed as a full screen.

Since connection to the content servers is done using wideband cellular communication channels via the cellular basic unit 15 (which may be a 3G cellular modem), content may be consumed by streaming it over the established cellular internet channel (for example, streamed music or TV programs may be provided to the driver).

In a similar way in the form of a sub-menu, the UI may offer any required service, such as connecting to the mailbox, receiving general information such as whether condition, news, upcoming events etc. Several services can be offered in a pull mode, when the driver activates a relevant sub-menu whenever desired. Other services can be offered in a push mode, when the driver is passive and a relevant sub-menu is displayed according to the car's location and traffic conditions. In addition, the driver can receive messages about upcoming events or information of interest, such as birthday reminders in the driver's mailbox, new songs of favorite artist that the driver is used to hear, etc. All this is done by pressing large icons which are sufficiently spaced from each other and with minimal attention from the driver. FIG. 2B schematically illustrates a sub-menu displayed on the touchscreen of the UI, that offers inter alia, cellular parking. If the driver so desires, he can press the relevant icon 14f and reach the next screen, shown in FIG. 2C. In this screen, he can see a map with the location of the nearest parking area 14g. In addition, a bar 14h is displayed, for allowing the driver to activate parking by pressing that bar. This sub-menu also offers information about traffic jams by pressing icon 14i, to reach a screen that displays a map, shown in FIG. 2D, on which jammed routs are illustrates by a graphical symbol 14j. The sub-menu displayed on the touchscreen of the UI, also offers access to the driver's mailbox. If the driver so desires, he can press the relevant icon 14k and reach the next screen, shown in FIG. 2E. In this screen, he can see messages stored in his remote mailbox 14l. Another sub-menu displayed on the touchscreen of the UI and shown in FIG. 2E, may also inform the driver about an upcoming lottery game by a banner 14m, in case he will be interested in participating. If the driver so desires, he can stop nearby and by a ticket from the nearest lottery booth, the location of which is shown on the area map using symbol 14n. Alternatively, the driver can remotely participate in a game using a relevant sub-menu in the UI.

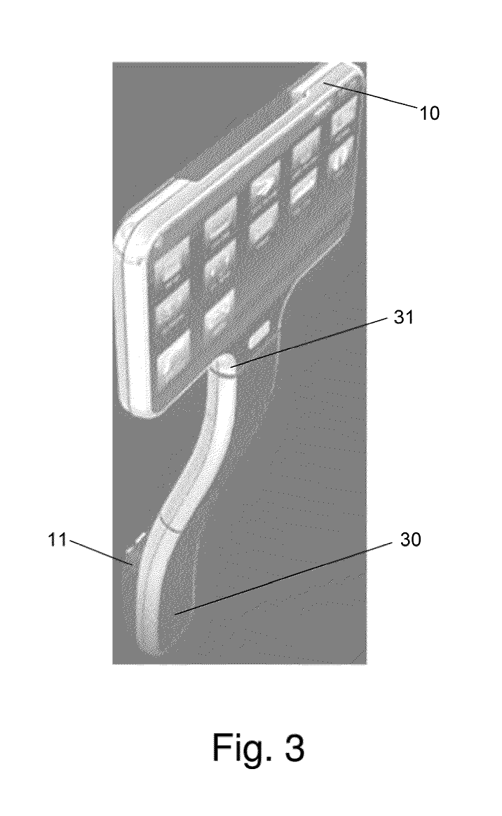

FIG. 3 schematically illustrates the mounting orientation of the UI, according to a preferred embodiment of the present invention. The UI 10 is connected to a curved metallic arm that is has a base 11 with robust connection to the vehicle chassis. The arm 12 comprises two joints 30 and 31 that can be adjust by the driver for determining the location and orientation of the UI, in order to be optimally matched to each driver. The arm 12 of the UI may also comprise a telescopic sleeve (not shown) for changing the total length of the arm. Alternatively, the user interface unit may have mechanical connections (e.g., threads and screws) for allowing rigid mounting to the dashboard of the vehicle, where the inherent audio system is normally installed. A decorative panel may also be added, to match the appearance of the dashboard.

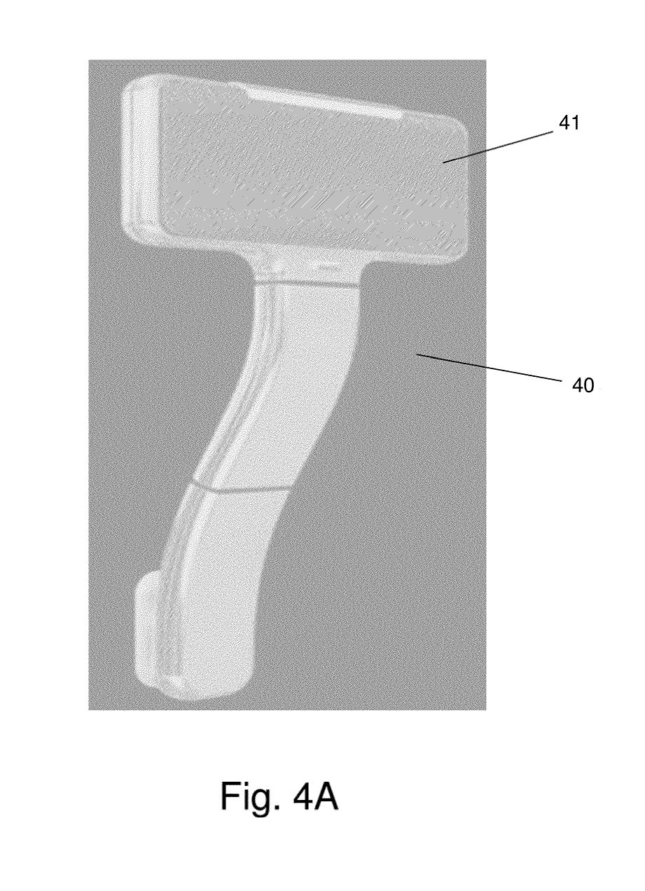

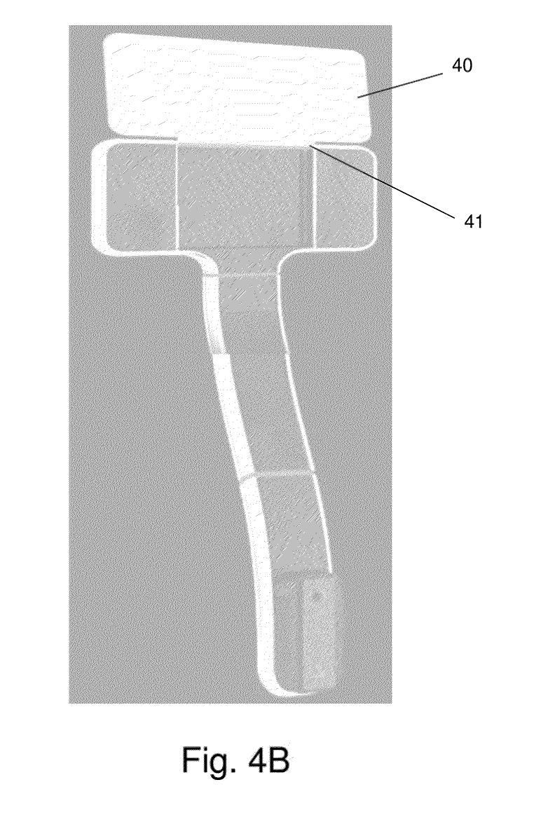

FIGS. 4A and 4B schematically illustrate a UI that comprises a cover, according to a preferred embodiment of the present invention. The cover 40 may be attached to the top edge of the UI by an appropriate hinge and may be metallic or made of any suitable material that can be used to protect the touchscreen when the UI is inactive. The system installed in the vehicle may comprise replaceable panels for enriching the decorative fractures that can be adapted to optimally fit the dashboard of the vehicle.

According to a preferred embodiment of the invention, several services can be “pushed” (positively offered) to the driver by the UI, such as location-based reminders, recommendations about places of interest according to the driver's profile, which forms a single with voice and visual console for providing location-based services, that is optimally adapted to the driver's environment both functionally and aesthetically, without the need for cumbersome browsing between many menus.

According to another embodiment, the UI may comprise a light sensor for changing the intensity of the display, so as to bring it to the optimal value for any level of ambient light. Alternatively, the intensity of the display may be changed according to time (day or night hours), without the need for a light sensor. The managing software is also adapted to dynamically update the offered services, add new services and remove non-relevant services. In addition, the UI may be also connected to the vehicle's computer or ignition system, in order to identify whether the vehicle's engine has been operated by the driver. From that moment, the system can start delivering messages to the driver, such as bursting messages in case of approaching a dangerous area, an accident area etc. In this case, the bursting messages will occupy the full screen for a predetermined time, regardless the current active application. In addition, the system may be adapted to collect information about the vehicle movement from starting driving the vehicle, for allowing control operations and monitoring, as well as reporting about the driving patterns of a specific driver.

It is also possible to a projector in the user interface unit, for displaying desired content on an external media, such as the front window of the vehicle, or using augmented reality means.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A system for providing cellular services to a driver of a motor vehicle, comprising:
a) a user interface unit that includes:
a.1) a touchscreen for displaying a desired content and icons being input keys to receive inputs from said driver;
a.2) a memory with dedicated managing software for controlling the offered services and inputs from the touch-screen;
a.3) a cellular basic unit for providing voice and data communication between said user interface unit and a cellular base station to thereby provide content and cellular services from one or more remote servers over a data network;
a.4) a local interfacing application for generating a dedicated interface, adapted to be compatible with the vehicular environment of said driver, by modifying the interface of said content and cellular services being rendered on said remote servers;
a.5) a processor and operating system for controlling the operation of said user interface unit;
b) a rigid panel for holding said user interface unit; and
c) one or more remote servers for providing content and cellular services to said user interface unit.

2. A system according to claim 1, further comprising a remote interfacing application residing at an intermediate remote server, or on said remote servers, for interacting with the local interfacing application to jointly generate the dedicated interface.

3. A system according to claim 1, in which the user interface unit further comprises a mounting arm connected to a rigid mounting base, rigidly connected to the body of said vehicle, such that said panel is being in a spatial orientation desired by the driver.

4. A system according to claim 1, in which the user interface unit further comprises a short-range transceiver and the cellular basic unit is a cellphone with a short-range transceiver used by the driver in said vehicle, which further comprises a short-range transceiver to provide voice and data communication between said user interface unit and a cellular base station through said cellphone.

5. A system according to claim 1, in which the arm further comprises one or more joints to be adjusted by the driver for determining the location and orientation of the UI and a telescopic sleeve for changing the total length of said arm.

6. A system according to claim 1, in which the services include music, phone calls, TV, road services, Internet, SMS, email access, receiving general information.

7. A system according to claim 1, in which the arm further comprises one or more joints to be adjusted by the driver for determining the location and orientation of the user interface unit and a telescopic sleeve for changing the total length of said arm.

8. Apparatus according to claim 1, in which the user interface unit further comprises a protecting cover, attached to the edge of the UI by an appropriate hinge.

9. A system according to claim 1, in which the user interface unit further comprises a light sensor for providing data for changing the intensity of the display according to the level of ambient light.

10. A system according to claim 1, in which the user interface unit is programmed to change the intensity of the display according to the time.

11. A system according to claim 1, in which the user interface unit further comprises a GPS for providing location based content and cellular services.

12. A system according to claim 1, in which the dedicated interface is generated dynamically, according to the specific accessed content or cellular service.

13. A system according to claim 1, in which the data network is the internet.

14. A system according to claim 1, in which the user interface unit further comprises mechanical connections for allowing a rigid connection to the dashboard of the vehicle.

15. A system according to claim 1, in which the user interface unit is connected to the inherent audio system of the vehicle.

16. A system according to claim 1, in which content is delivered to the user interface unit by streaming.

17. A system according to claim 1, in which services or applications are activate via the user interface unit by voice commands and associated voice recognition application.

18. A system according to claim 1, in which at least a part of the dedicated interface is generated dynamically according to the specific accessed content or cellular service and displayed according to a predetermined visual appearance.

19. A system according to claim 1, further comprising presence sensors for detecting abandoned persons inside the vehicle.

20. A system according to claim 1, further comprising detection sensors for generating an alarm signal whenever the driver does not keep a minimal safety distance from neighboring vehicles.

21. A system according to claim 1, further comprising a rear camera for viewing the road while driving in a reverse direction.

22. A system according to claim 1, in which data from sensors is received to the user interface unit via wired or wireless connection.

23. A system according to claim 1, further comprising a projector in the user interface unit, for displaying desired content on an external media.

24. A user interface unit for providing cellular services to a driver of a motor vehicle, comprising:
a) a touchscreen for displaying a desired content and icons being input keys to receive inputs from said driver;
b) a memory with dedicated managing software for controlling the offered services and inputs from the touch-screen;
c) a cellular basic unit for providing voice and data communication between said user interface unit and a cellular base station to thereby provide content and cellular services from one or more remote servers over a data network;
d) a local interfacing application for generating a dedicated interface, adapted to be compatible with the vehicular environment of said driver, by modifying the interface of said content and cellular services being rendered on said remote servers;
e) a processor and operating system for controlling the operation of said user interface unit; and
f) a rigid panel for holding said user interface unit.
